(19) United States
(12) Patent Application Publication
(10) Pub. No.: US 2026/0237641 A1
(43) Pub. Date: Aug. 13, 2026

(54) ELECTRODE

(71) Applicant: TOYOTA JIDOSHA KABUSHIKI KAISHA, Toyota-shi (JP)

(72) Inventor: Takanori MAHARA, Toyota-shi (JP)

(73) Assignee: TOYOTA JIDOSHA KABUSHIKI KAISHA, Toyota-shi (JP)

(21) Appl. No.: 19/438,765

(22) Filed: Jan. 2, 2026

(30) Foreign Application Priority Data
Jan. 16, 2025 (JP) 2025-006227

(51) Int. Cl. H01M 4/36; H01M 4/02; H01M 4/136; H01M 4/58

(52) U.S. Cl. CPC H01M 4/364; H01M 4/136; H01M 4/5825; H01M 2004/021; H01M 2004/028

(57) ABSTRACT

An electrode includes a current collector foil and a cathode layer, in which the cathode layer is disposed on a surface of the current collector foil, the positive electrode layer contains a cathode active material, the cathode active material contains non-spherical particles, the non-spherical particles contain an olivine phosphate compound, and circularity of the non-spherical particles is 0.50 or less.

### CROSS-REFERENCE TO RELATED APPLICATION

This application claims priority to Japanese Patent Application No. 2025-006227 filed on Jan. 16, 2025. The disclosure of the above-identified application, including the specification, drawings, and claims, is incorporated by reference herein in its entirety.

### BACKGROUND

### 1. Technical Field

The present disclosure relates to an electrode.

### 2. Description of Related Art

Japanese Unexamined Patent Application Publication (Translation of PCT Application) No. 2016-524307 (JP 2016-524307 A) discloses using lithium manganese iron phosphate (LMFP) as a cathode active material for lithium-ion batteries, and that the LMFP has a substantially spherical shape.

### SUMMARY

An object of the present disclosure is to improve adhesion between a current collector foil and a cathode layer.

A technical configuration and effects of the present disclosure will be described below. Note that mechanisms of action include speculation. The mechanisms of action do not limit the technical scope of the present disclosure.

[1] An electrode including a current collector foil and a cathode layer, in which the cathode layer is disposed on a surface of the current collector foil, the cathode layer contains a cathode active material, the cathode active material contains non-spherical particles, the non-spherical particles contain an olivine phosphate compound, and circularity of the non-spherical particles is 0.50 or less.

Conventionally, olivine phosphate compounds are synthesized so as to approximate a spherical shape. This is because it is thought that improved filling properties, i.e., improved energy density, can be anticipated due to the olivine phosphate compounds being spherical particles.

The electrode according to the present disclosure includes non-spherical particles. In the present disclosure, the non-spherical particles have a circularity of 0.50 or less. Non-spherical particles have distorted shapes. Non-spherical particles can have angular portions, for example. Non-spherical particles tend to be oriented in the electrode (cathode layer) with their angular portions following a thickness direction of the electrode. The non-spherical particles are contained in the electrode, causing the non-spherical particles to penetrate into the current collector foil (anchor effect). As a result, improved adhesion between the cathode layer and the current collector foil is anticipated.

[2] The electrode according to [1], in which the non-spherical particles are present at an interface of the current collector foil and the cathode layer, and a contact rate of the non-spherical particles at the interface is 50% or more.

It is anticipated that when these conditions are satisfied, adhesion between the cathode layer and the current collector foil will be improved.

[3] The electrode according to [1] or [2], in which the cathode active material further includes spherical particles, the non-spherical particles contain an olivine phosphate compound, and circularity of the spherical particles is 0.80 or more.

Due to the cathode active material containing the spherical particles and the non-spherical particles, improved balance between adhesion and filling properties, for example, is anticipated.

[4] The electrode according to [3], in which a ratio of the non-spherical particles as to a total of the non-spherical particles and the spherical particles in the cathode active material is greater than 5% in terms of mass fraction.

Improved adhesion between the cathode layer and the current collector foil due to including a certain amount or more of non-spherical particles in the cathode active material is anticipated.

[5] The electrode according to any one of [1] to [4], in which the olivine phosphate compound includes at least one selected from a group consisting of lithium iron phosphate, lithium manganese phosphate, and lithium manganese iron phosphate.

An embodiment of the present disclosure (hereinafter may be abbreviated to “present embodiment”) and an example of the present disclosure (hereinafter may be abbreviated to “present example”) will be described below. It should be noted, however, that the present embodiment and the present example do not limit the technical scope of the present disclosure. The present embodiment and the present example are exemplary in all respects. The present embodiment and the present example are non-limiting. The technical scope of the present disclosure encompasses all changes within the meaning and scope equivalent to the description of the claims. For example, it is planned from the beginning that optional configurations may be extracted from the present embodiment and optionally combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a portion of an electrode according to an embodiment;

FIG. 2 is a diagram illustrating a measurement method of a contact rate according to the embodiment;

FIG. 3 is a conceptual diagram of a non-spherical particle according to the embodiment;

FIG. 4 is a schematic diagram illustrating a lithium ion secondary battery according to the embodiment; and

FIG. 5 is a table showing experimentation results.

### DETAILED DESCRIPTION OF EMBODIMENTS

### Terms and Phrases

“Comprise,” “include,” “have,” and variations thereof are open ended expressions. A configuration expressed as open ended may or may not further include additional elements in addition to essential elements.

The shapes of non-spherical particles and spherical particles are evaluated by the following procedure. For example, 1 g of a cathode active material (powder) is dispersed in 10 g of epoxy resin (product name “EPOTEXJP”, manufactured by Nisshin EM Co., Ltd.) to form a dispersion liquid. The dispersion liquid is stirred and mixed for 1 minute using a mixer (product name: “Awatori Rentaro”, manufactured by Thinky Corporation). The stirring speed may be, for example, about 2000 rpm. The dispersion liquid is vacuum degassed. After vacuum degassing, the epoxy resin is cured inside a silicone mold, yielding a plate-shaped cured product. The plate-shaped cured product is subjected to cross-section processing using a Cross Section Polisher (registered trademark) to prepare a cross-sectional sample having a smooth cross section. A cross-sectional SEM image is obtained by performing scanning electron microscope (SEM) observation of the smooth cross section.

The circularity of particles is measured regarding particles of which the entire periphery thereof is observable in the cross-sectional SEM image. The “circularity” is found by the following expression.
ψ=4πS/L²
ψ: circularity
π: pi
S: cross-sectional area of particle (area of region surrounded by outline of particle)
L: Particle circumferential length (length of particle outline)

Particles with a circularity of 0.80 or more are classified as spherical particles.

The average value of the circularity in a set of spherical particles is the “average circularity of spherical particles.” Particles with a circularity of 0.50 or less are classified as non-spherical particles. The average value of the circularity in a set of non-spherical particles is the “average circularity of non-spherical particles”. Note that the average value of circularity is the average value of 50 particles.

Referencing FIG. 2, a contact rate of non-spherical particles at an interface of a current collector foil and the cathode layer is evaluated by the following procedure. A cross-section sample of an electrode is prepared. A cross-sectional SEM image is obtained by performing SEM observation of the cross-section. The field of view of the cross-sectional SEM image is adjusted such that an interface 13 is included therein, over a range of around 50 μm in a width direction W. In the cross-sectional SEM image, non-spherical particles 1a and spherical particles 1b that are in contact with each other at the interface 13 are confirmed. Regarding the non-spherical particles 1a, a length of a line segment connecting the two farthest points thereof in the width direction W so as to be parallel to the interface is defined as “cₙ”, and regarding the spherical particles 1b, a length of a line segment connecting the two farthest points thereof in the width direction W so as to be parallel to the interface is defined as “dₙ”. With a sum of cₙ as “S_{c}” and a sum of dₙ as “S_{d}”, the contact rate (%) is found by “100×S_{c}/(S_{c}+S_{d})”.

Note that various dimensional measurements and shape analyses of cross-sectional SEM images can be performed using, for example, image analysis software such as “ImageJ” or the like.

The chemical composition of a compound can be measured by inductively coupled plasma atomic emission spectroscopy (ICP-AES). A sample solution is prepared by dissolving 0.1 g of a sample (e.g., cathode active material) in a mixed acid (10 ml) of hydrochloric acid and sulfuric acid. The sample solution is diluted to an appropriate concentration using a volumetric flask. After dilution, composition analysis is performed using an ICP-AES device.

A stoichiometric formula represents a representative composition of a compound. The compound may have a non-stoichiometric composition. For example, “Al₂O₃” is not limited to compounds having a molar ratio of “Al/O=⅔”. Unless otherwise specified, “Al₂O₃” refers to compounds containing Al and O in any molar ratio. For example, the compound may be doped with a trace element. Al and O may be partially substituted with another element.

“D50” indicates the particle size at which a cumulative value becomes 50% in a volume-based particle size distribution (cumulative distribution). The volume-based particle size distribution is measured by a laser diffraction particle size distribution measuring device.

“Maximum Feret diameter” refers to a length of a long side of a minimum bounding rectangle (MBR) relative to the outline of a particle in a cross-sectional SEM image.

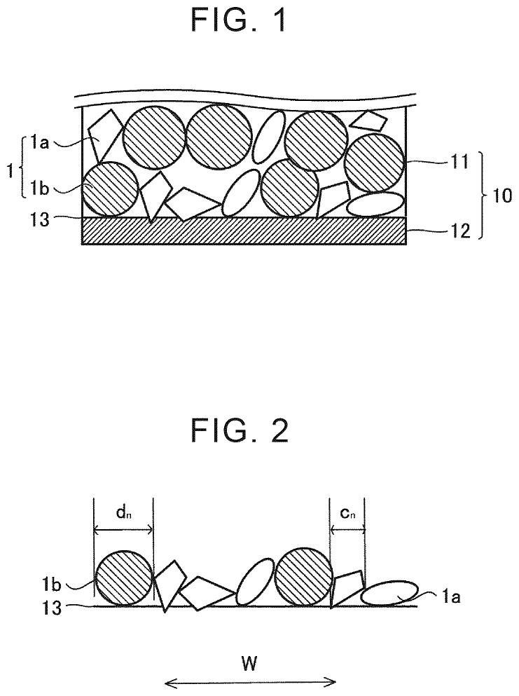

FIG. 1 is a schematic cross-sectional view of a portion of an electrode according to the present embodiment. The electrode 10 may be, for example, a cathode electrode of a monopolar battery. The electrode 10 includes a current collector foil 12 and a cathode layer 11.

The current collector foil 12 is a conductor. The current collector foil 12 supports the cathode layer 11. The current collector foil 12 may be, for example, in the form of a sheet. The thickness of the current collector foil 12 may be, for example, 1 to 50 μm, 3 to 30 μm, or 5 to 15 μm. The current collector foil 12 has electroconductivity. The current collector foil 12 may include, for example, a metal foil or the like. The current collector foil 12 may contain, for example, at least one type selected from a group consisting of Cu, Ni, Zn, Pb, Al, Ti, Fe, Ag, and Au, and an electroconductive resin. The current collector foil 12 may include, for example, an Al foil, an Al alloy foil, or the like. The current collector foil 12 may have, for example, a multi-layer structure. For example, the current collector foil 12 may be formed by bonding an Al foil and a Cu foil together.

The cathode layer 11 is disposed on the surface of the current collector foil 12. The cathode layer 11 may be disposed on just one face of the current collector foil 12. The cathode layer 11 may be disposed on both faces of the current collector foil 12. When the electrode 10 is a bipolar battery, the cathode layer 11 can be disposed on one face (front face) of the current collector foil 12, and also an anode layer (omitted from illustration) can be disposed on the other face (rear face). The thickness of the cathode layer 11 may be, for example, 10 μm or more, 100 μm or more, 200 μm or more, 400 μm or more, 600 μm or more, 800 μm or more, or 1 mm or more. The thickness of the cathode layer 11 may be, for example, 1.2 mm or less, 1 mm or less, or 800 μm or less. In a bipolar structure, a cathode layer 11 that is thick, i.e., having a thickness of 200 μm or more, may be required.

The cathode layer 11 contains a cathode active material 1. That is to say, the electrode 10 contains the cathode active material 1.

The cathode active material 1 may be in a form of, for example, powder. The D50 of the cathode active material 1 may be, for example, 5 μm or more, 10 μm or more, 15 μm or more, or 20 μm or more. The D50 of the cathode active material 1 may be, for example, 30 μm or less, 25 μm or less, 20 μm or less, 15 μm or less, or 10 μm or less.

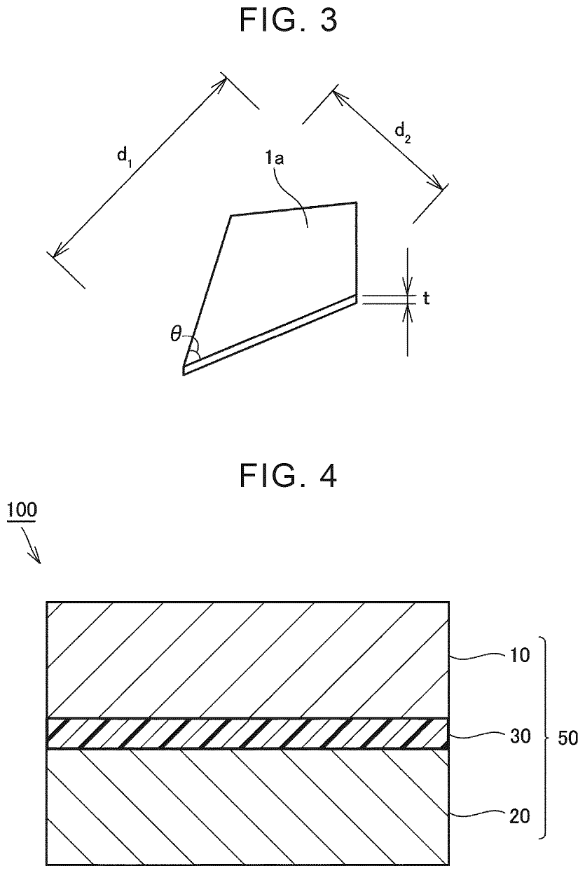

FIG. 3 is a conceptual diagram of a non-spherical particle according to the present embodiment. The cathode active material 1 includes non-spherical particles 1a. The non-spherical particles 1a have a circularity of 0.50 or less.

The circularity (average circularity) of the non-spherical particles 1a may be, for example, 0.45 or less, 0.42 or less, or 0.40 or less. The circularity of the non-spherical particles 1a may be 0.30 or more, 0.35 or more, 0.38 or more, or 0.40 or more. The circularity of the non-spherical particles 1a may be, for example, 0.30 or more and 0.50 or less, or 0.35 or more and 0.45 or less.

The non-spherical particles 1a may be, for example, angular particles. “Angular particles” refers to particles having a most acute angle “θ” of 60° or less. The term “most acute angle” refers to the smallest acute angle among interior angles formed by the outline of a particle in a cross-sectional SEM image. The most acute angle may be, for example, 50° or less, 40° or less, 30° or less, or 20° or less. The most acute angle may be, for example, 10° or more, 20° or more, 30° or more, 40° or more, or 50° or more. The angular particles may have, for example, a plurality of acute corners, including the most acute angle.

The non-spherical particles 1a may be, for example, scale-like particles. The “scale-like particles” are plate-like particles and also angular particles. A “plate-like particle” has a planar direction (plate face direction) and a thickness direction. A “first aspect ratio” indicates a ratio of the maximum Feret diameter “d₁” in the plate face direction to the thickness “t” of the plate-like particle. The first aspect ratio “d₁/t” may be, for example, 2 or more, 3 or more, 5 or more, 7 or more, or 9 or more. The first aspect ratio “d₁/t” may be, for example, 10 or less, 9 or less, 7 or less, 5 or less, or 3 or less.

With regard to the plate-like particles, the plate faces can have any shape. The term “plate face” refers to a face that appears to have the largest area. The plate face may be, for example, polygonal, square, parallelogram-like, rectangular, or the like. A “second aspect ratio” refers to a ratio of a long side “d₁” to a short side “d₂” of the MBR relative to the plate face of the plate-like particle. The second aspect ratio “d₁/d₂” may be, for example, 1.2 or greater, 1.5 or greater, 2.0 or greater, 3.0 or greater, 4.0 or greater, or 5.0 or greater. The second aspect ratio “d₁/d₂” may be, for example, 10.0 or less, 5.0 or less, 4.0 or less, 3.0 or less, or 2.0 or less.

The cathode active material 1 may further contain spherical particles 1b in addition to the non-spherical particles 1a. The spherical particles 1b have a circularity of 0.80 or more. The average circularity of the spherical particles 1b may be, for example, 0.85 or more, 0.90 or more, or 0.91 or more. The average circularity of the spherical particles 1b may be, for example, 0.95 or less, 0.93 or less, or 0.91 or less. The average circularity of the spherical particles 1 b may be, for example, 0.80 or more and 0.95 or less, or 0.90 or more and 0.93 or less.

The cathode active material 1 may contain the non-spherical particles 1a at a particular ratio. The ratio of the non-spherical particles 1a to the total of the non-spherical particles 1a and the spherical particles 1b in the cathode active material 1 (hereinafter also referred to as “mass ratio of non-spherical particles”) may be, for example, more than 5% in mass fraction. The mass ratio of non-spherical particles may be, for example, 8% or more, 10% or more, 15% or more, 20% or more, 25% or more, 30% or more, 35% or more, 40% or more, or 45% or more. The mass ratio of non-spherical particles may be, for example, 50% or less, 45% or less, 40% or less, 35% or less, 30% or less, 25% or less, 20% or less, 15% or less, or 10% or less. The mass ratio of non-spherical particles may be, for example, more than 5% and 50% or less, or may be 10% or more and 30% or less.

The surface of the cathode active material 1 (non-spherical particles 1a and spherical particles 1b) may be coated with carbon. That is to say, a carbon layer may be formed on the surface of the cathode active material 1. The carbon may cover part of the surface of the cathode active material 1 or may cover the entire surface of the cathode active material 1. The carbon may be derived from, for example, sugars or the like. The amount of carbon adhering may be, for example, 0.1% or more, 0.5% or more, 1% or more, 5% or more, or 10% or more, in mass fraction relative to the cathode active material 1. The amount of carbon adhering may be, for example, 20% or less, 15% or less, 10% or less, 5% or less, or 3% or less in mass fraction relative to the cathode active material 1.

The non-spherical particles 1a contain an olivine phosphate compound. That is to say, the cathode active material 1 contains an olivine phosphate compound. The spherical particles 1b may contain an olivine phosphate compound. Hereinafter, the term “olivine phosphate compound” may be abbreviated to “olivine”. Olivine has a crystal structure that belongs to space group Pnma. The space group to which the crystal structure belongs is identified by X-ray diffraction (XRD) pattern.

Olivine may further include, for example, a glass phase, a glass-ceramic phase, and so forth, in addition to a crystalline phase. For example, the non-spherical particles 1a may be formed by pulverizing a glass-containing material as appropriate. For example, a glass-ceramic phase or the like can be formed by first vitrifying raw materials during synthesis and then performing crystallizing thereof.

The olivine may contain, for example, at least one selected from a group consisting of lithium iron phosphate (LFP), lithium manganese phosphate (LMP), and LMFP. The olivine may contain, for example, at least one selected from a group consisting of LMP and LMFP.

Olivine may have a composition represented by the general formula “LiₐMn₁₋ₓFeₓPO₄”, for example. In the general formula, for example, a relation of “0.5≤a≤1.5” may be satisfied. In the general formula, for example, a relation of “0.2≤x≤0.5” may be satisfied.

The cathode active material 1 may further contain other components as long as olivine is contained therein. A mixing ratio (mass ratio) of olivine to other components may be, for example, “olivine/other components=9/1 to 1/9” or “olivine/other components=7/3 to 3/7”. The cathode active material 1 may be, for example, a mixture of olivine powder and powder of other components. The other components may include, for example, at least one selected from a group consisting of Li[NiCoMn]O₂ (layered structure), Li[NiCoAl]O₂ (layered structure), LiMnO₂ (rock salt structure), and Li[NiMn]₂O₄ (spinel structure). It should be noted that descriptions such as “[NiCoMn]” or the like indicate that the sum of the composition ratios in the brackets is 1. As long as the total is 1, the components in the brackets can have any composition ratio.

The non-spherical particles 1a may be present at the interface 13 of the current collector foil 12 and the cathode layer 11. The contact rate of the non-spherical particles 1a at the interface 13 (hereinafter also simply referred to as “contact rate”) may be 50% or more. The contact rate is, for example, 55% or more, 60% or more, or 63% or more. Alternatively, the contact rate may be 65% or more. The contact rate may be, for example, 80% or less, 75% or less, 70% or less, or 69% or less. The contact rate may be, for example, 50% or more and 80% or less, or 60% or more and 70% or less.

In addition to the cathode active material 1, the cathode layer 11 may further contain, for example, an electroconductive material, a binder, a thickener, and so forth. For example, the content of the electroconductive material may be, for example, 0.1 parts by mass to 10 parts by mass, with respect to 100 parts by mass of the cathode active material 1. The electroconductive material may include any component. The electroconductive material may include, for example, at least one selected from a group consisting of graphite, acetylene black (AB), Ketjen black (registered trademark), vapor-grown carbon fibers (VGCF), carbon nanotubes (CNT), and graphene flakes (GF).

For example, the content of the binder may be, for example, 0.1 parts by mass to 10 parts by mass, with respect to 100 parts by mass of the cathode active material 1. The binder may include any component. The binder may contain, for example, at least one selected from a group consisting of polyvinylidene fluoride (PVdF), vinylidene fluoride-hexafluoropropylene copolymer (PVdF-HFP), styrene butadiene rubber (SBR), carboxymethyl cellulose (CMC), polyacrylic acid (PAA), polyvinylpyrrolidone (PVP), and derivatives thereof. SBR, CMC, PAA, PVP, and the like can also function as thickeners.

In the present embodiment, the current collector foil 12 may have dents. The dents can be caused by the non-spherical particles 1a. The dents can be confirmed by the following procedure. The electrode is stripped into the current collector foil and the cathode layer, using an organic solvent and water. After stripping, the surface of the current collector foil (10 mm×10 mm) is observed regarding whether there are 10 or more recesses. The observation may be performed using, for example, a microscope or a laser microscope.

The electrode according to the present embodiment includes non-spherical particles. Thus, improved adhesion between the current collector foil and the cathode layer is anticipated. The improvement in adhesion is anticipated to lead to, for example, a reduction in the amount of binder and an improvement in rate characteristics. It is anticipated that due to the non-spherical particles being oriented along the thickness direction of the electrode, a permeation path of electrolytic solution in the thickness direction of the electrode will be linearized. It is anticipated that rate characteristics will improve due to improving diffusivity of the electrolytic solution in the thickness direction of the electrode.

### Lithium-ion Secondary Battery

FIG. 4 is a schematic diagram illustrating a lithium-ion secondary battery (hereinafter, may be abbreviated to “battery”) according to the present embodiment. A battery 100 includes a power generating element 50 and an electrolytic solution (omitted from illustration). The battery 100 may include an outer encasement. The outer encasement may house the power generating element 50 and the electrolytic solution. The outer encasement may be, for example, a metal case, a pouch made of an Al laminate film, or the like.

The power generating element 50 can have any form. The power generating element 50 may be, for example, a wound type, a laminated type, or the like. The power generating element 50 may have a monopolar structure or a bipolar structure. The power generating element 50 includes a cathode 10, an anode 20, and a separator 30. The separator 30 is disposed between the cathode 10 and the anode 20. The electrolytic solution permeates gaps between the components and gaps within the components. Each of the members may be, for example, in the form of a sheet.

### Anode

The anode 20 may include an anode current collector and an anode active material layer. The anode current collector may include, for example, Cu foil or the like. The anode active material layer contains an anode active material. The anode active material may include, for example, at least one selected from a group consisting of graphite, soft carbon, and hard carbon. The anode active material layer may further contain, for example, an electroconductive material, a binder, a thickener, and so forth.

The electroconductive material may include, for example, CNTs or the like. The binder may include, for example, CMC, SBR, or the like. The content of the electroconductive material and the binder may be, for example, 0.1 to 10 parts by mass with respect to 100 parts by mass of the anode active material.

### Separator

The separator 30 is porous. The separator 30 is permeable regarding the electrolytic solution. The separator 30 separates the cathode 10 and the anode 20. The separator 30 is electrically insulating. The separator 30 may contain, for example, a polyolefin resin or the like, such as polyethylene (PE), polypropylene (PP), or the like. The separator 30 may have, for example, a single-layer structure, or may have a multi-layer structure. The separator 30 may be, for example, substantially made of a PE layer, or may be formed by laminating a PP layer, a PE layer, and a PP layer in this order. A heat-resistant layer, for example, may be formed on the surface of the separator 30.

### Electrolytic Solution

The electrolytic solution includes a solvent and a Li salt. The solvent is aprotic. The solvent can contain any component. The solvent may contain, for example, at least one type selected from a group consisting of ethylene carbonate (EC), dimethyl carbonate (DMC), and ethyl methyl carbonate (EMC).

The Li salt is the supporting electrolyte. The Li salt is dissolved in the solvent. The Li salt may include, for example, at least one type selected from a group consisting of LiPF₆ and LiBF₄. The Li salt may have a molar concentration of, for example, 0.5 mol/L or more and 2.0 mol/L or less.

The electrolytic solution may further contain any additive. The electrolytic solution may contain, for example, 0.01% by mass or more to 5% by mass or less of an additive. The additive may include, for example, at least one type selected from a group consisting of vinylene carbonate (VC), vinyl ethylene carbonate (VEC), and so forth.

Note that a solid electrolyte may be used instead of the electrolytic solution and the separator 30. That is to say, in the present embodiment, the battery may be an all-solid-state battery.

### Production of Cathode Active Material

### No. 1

Raw materials of lithium carbonate, manganese carbonate, iron oxalate, and phosphoric acid were each weighed out to achieve a composition ratio represented by the composition formula “Li₁Mn_{0.8}Fe_{0.2}PO₄”. Powdered materials other than phosphoric acid were mixed together to form a mixture. While adding phosphoric acid to the mixture, the mixture was pulverized and mixed in a mortar until the reaction stopped, thereby forming a powder of the mixture. At this time, generation of gas can be suppressed by gradually adding phosphoric acid. The mixture powder was placed in a graphite crucible. The graphite crucible was placed in a firing furnace. Firing was carried out in an inert atmosphere according to the following procedure. First, heating is performed such that the temperature is increased at a rate of 5° C./min until the temperature inside the furnace reaches 1100° C. The furnace temperature of 1100° C. is maintained for 1 hour. After maintaining this temperature for 1 hour, cooling is performed such that the temperature is reduced at a rate of 5° C./min until the temperature inside the furnace reaches 600° C. Thereafter, cooling is performed such that the temperature is reduced at a rate of 15° C./min until the temperature inside the furnace reaches room temperature. As a result, a glassy mass of active material is obtained. A precursor is formed by pulverizing the active material mass using mechanical pulverizing equipment.

To the precursor, 10% by mass fraction of fructose was added to form a precursor mixture. The precursor mixture was pulverized in a water solvent using a bead mill to form a first slurry. During pulverizing, beads (pulverizing media) having a diameter (φ) of 0.1 mm are used. The circumferential speed is 10 m/s. The pulverizing time is 60 minutes.

The first slurry was dried to obtain a dried product. The dried product was placed in a graphite crucible. The graphite crucible was placed in a firing furnace. Thermal treatment (firing) was carried out at 650° C. in an inert atmosphere to produce a cathode active material (LMFP) of No. 1.

### No. 2

The precursor obtained in No. 1 was dispersed in water and pulverized using a colloid mill (magic LAB, (registered trademark)) with target gap adjusted to zero to form a second slurry. Rotation speed of rotor during pulverizing was 16,000 rpm. The pulverizing time is 10 minutes.

The first slurry and the second slurry were mixed such that the mass fraction of the cathode active material contained in the slurry was 95:5, so as to obtain a third slurry. To the third slurry, fructose was added in an amount of 10% by mass fraction, and then dried to obtain a dried product. The dried product was placed in a graphite crucible. The graphite crucible was placed in a firing furnace. Thermal treatment (firing) was carried out at 650° C. in an inert atmosphere to produce a cathode active material No. 2.

### No. 3

A cathode active material was prepared in the same manner as in No. 2, except that the mass fraction of the cathode active material contained in the first slurry and the second slurry was changed to 90:10.

### No. 4

A cathode active material was prepared in the same manner as in No. 3, except that the pulverizing time in the colloid mill was changed to 30 minutes.

### Fabrication of Cathode

The cathode active material, an electroconductive material (acetylene black), and a binder (PVdF) were mixed to form a mixture. A mixing ratio (mass ratio) was “cathode active material/electroconductive material/binder=92/5/3”. The mixture was dispersed in a solvent (N-methyl-2-pyrrolidone) to form a paste. The solid content concentration of the paste was 50% by mass fraction. The paste was applied to the surface of an Al foil and dried to form a cathode layer. The density of the cathode layer was adjusted to 1.8 g/cm³ by roll pressing, thereby forming a cathode.

### Evaluation

### Circularity

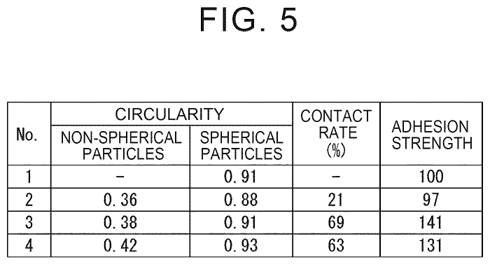

A cross-sectional SEM image of the cathode active material was obtained by the above-described method. The circularity of non-spherical particles and spherical particles was measured in cross-sectional SEM images. The results thereof are shown in FIG. 5.

### Contact Rate

A cross-sectional SEM image of the electrode (cathode) was obtained by the above-described method. In the cross-sectional SEM images, the contact rate of non-spherical particles at the interface of the Al foil and the cathode layer was measured. The results thereof are shown in FIG. 5.

### Adhesion Strength

The cathode was cut into a shape of 20 mm×30 mm. After cutting, the piece was attached to a peel test device using tape that was 10 mm wide. A peeling load (N), when the cathode layer was stripped off from the Al foil at an angle of 90° at a speed of 1 mm/sec, was measured. Taking into consideration the influence of stretching of the tape and so forth, an average of peeling loads, excluding 5 mm before and after the start of stripping, was taken as the adhesive strength. The results thereof are shown in FIG. 5. Note that values of the adhesive strength in FIG. 5 are relative values with the adhesion strength of No. 1 as 100.

### Results

When the conditions of the present disclosure are satisfied, adhesion between the current collector foil and the cathode layer tend to improve. The adhesion tends to improve when non-spherical particles and spherical particles are included, as well.

What is claimed is:

1. An electrode, comprising:
a current collector foil; and
a cathode layer, wherein
the cathode layer is disposed on a surface of the current collector foil,
the cathode layer contains a cathode active material,
the cathode active material contains non-spherical particles,
the non-spherical particles contain an olivine phosphate compound, and
circularity of the non-spherical particles is 0.50 or less.

2. The electrode according to claim 1, wherein
the non-spherical particles are present at an interface of the current collector foil and the cathode layer, and
a contact rate of the non-spherical particles at the interface is 50% or more.

3. The electrode according to claim 1, wherein
the cathode active material further includes spherical particles,
the spherical particles contain an olivine phosphate compound, and
circularity of the spherical particles is 0.80 or more.

4. The electrode according to claim 3, wherein a ratio of the non-spherical particles as to a total of the non-spherical particles and the spherical particles in the cathode active material is greater than 5% in terms of mass fraction.

5. The electrode according to claim 1, wherein the olivine phosphate compound includes at least one selected from a group consisting of lithium iron phosphate, lithium manganese phosphate, and lithium manganese iron phosphate.
